(19) United States
(12) Patent Application Publication
(10) Pub. No.: US 2024/0410031 A1
(43) Pub. Date: Dec. 12, 2024

(54) Solution Circulations in a Process for Calcination and Leaching of a Lithium-Containing Mineral

(71) Applicant: METSO FINLAND OY, Espoo (FI)

(72) Inventors: Marika TIIHONEN, Espoo (FI); Niko ISOMAKI, Espoo (FI); Tuomas HIRSI, Espoo (FI)

(73) Assignee: METSO FINLAND OY, Espoo (FI)

(21) Appl. No.: 18/699,957

(22) PCT Filed: Nov. 4, 2021
(86) PCT No.: PCT/FI2021/050748

§ 371 Date: Apr. 10, 2024

(51) Int. Cl. C22B 3/12; C01D 7/00; C01F 11/18; C22B 3/02; C22B 26/12

(52) U.S. Cl. CPC C22B 3/12; C01D 7/00; C01F 11/18; C22B 3/02; C22B 26/12; C01P 2006/80

(57) ABSTRACT

A method and arrangement for processing a lithium-containing mineral, including the recirculation of a carbonate-containing liquid stream back to an off-gas treatment unit.

### CROSS-REFERENCE TO RELATED APPLICATIONS

This application is the U.S. national stage application of International Application PCT/FI2021/050748, filed Nov. 4, 2021, which international application was published on May 11, 2023, as International Publication WO 2023/079208 A1 in the English language.

### BACKGROUND OF THE INVENTION

### Field of the Invention

The present invention relates to an arrangement and a method for processing a lithium-containing mineral, including the recirculation of a carbonate-containing liquid stream formed in a leaching step back to an off-gas treatment step.

### Description of Related Art

Hydrometallurgical processes for treating lithium-containing minerals, such as spodumene, typically include a calcination, where the mineral is subjected to high temperatures to increase the solubility of the mineral. Thus, for example the natural α-spodumene will turn into the more soluble β-spodumene. The high temperatures are typically achieved by burning a fuel, which generates exhaust gases. These exhaust gases are still hot, and are often generated in large amounts. Most fuels will also cause the formation of carbon dioxide (CO₂) into the exhaust gases.

Due to environmental concerns, such exhaust gases need to be handled, or cleaned.

Conventional gas-cleaning devices are mainly gas scrubbers that separate the solid particles from the exhaust gases, and leave the gaseous compounds at their original compositions. Since the exhaust gas (obtained from the high-temperature calcination) is hot, while the gas scrubber circulation has a lower temperature, a fraction of the scrubber washing water is evaporated when placed in contact with the gas. Since the evaporated water exits the scrubber with the washed gases as humidity, some make-up water is constantly needed in the scrubber. Fresh make-up water is also needed to replace the spent scrubber solution.

Thus, to avoid the need for constantly feeding fresh water to the process, while discarding aqueous solutions in other steps of the process, there is a need for further alternatives involving recirculations.

### SUMMARY OF THE INVENTION

The invention is defined by the features of the independent claims. Some specific embodiments are defined in the dependent claims.

According to a first aspect of the present invention, there is provided an arrangement and a method for processing a lithium-containing mineral, including recirculation of a carbonate-containing liquid stream to facilitate the reuse of carbonate reagents.

According to a second aspect of the present invention, there is provided an arrangement and a method for processing a lithium-containing mineral, including an improved procedure for handling or washing off-gases generated in a calcination step.

According to a third aspect of the invention, there is provided an arrangement and a method for processing a lithium-containing mineral, wherein a dilute alkaline carbonate solution formed during the mineral processing can be utilized as the washing solution of the off-gas treatment.

According to a fourth aspect, there is provided an arrangement and a method for processing a lithium-containing mineral, wherein the CO₂-containing off-gases from a calcination can be neutralized using a carbonate-containing solution recycled from the mineral processing.

The arrangement of the invention thus comprises the units intended for calcining the lithium-containing mineral, followed by two lines for further processing. In the first processing line, the calcined mineral material is processed in a unit for pulping the material, followed by a unit for leaching the material, whereafter a unit is provided for separating lithium-containing solids from a solution containing residual leaching reagent. In the second processing line, the off-gas formed by the calcination heat source is treated in an off-gas handling unit, among others by washing.

The present invention thus utilizes the liquid stream obtained from solid-liquid separation and recirculates at least a fraction of said liquid stream to the off-gas handling unit, to be used as the washing solution.

This new invention thus presents an integrated solution for replacing the conventionally used fresh water in the off-gas treatment, at least partly, with a dilute alkaline carbonate solution formed in a lithium extraction process.

Several advantages are achieved using the present invention. Among others, the use of a recirculated dilute process solution as off-gas washing solution will facilitate the spontaneous evaporation during the washing step. This will improve the hydrometallurgical process water balance, and will reduce the amount of liquid bleed out of the process. Moreover, since the recirculated solution includes carbonate ions, these can take part in a neutralization of carbon dioxide (CO₂) in the off-gas. Particularly, the carbonates in this dilute solution are alone capable of neutralizing about 5% of the CO₂ in the off-gas, but this percentage can easily be increased.

The optional neutralization of the CO₂ can be made even more effective by adding alkali, such as sodium hydroxide, to the off-gas treatment.

This neutralization of CO₂ will also produce a carbonate solution, which can be utilized in the process, e.g. by recirculating the solution obtained in this neutralization to the feed solution containing leaching reagents, which can be fed to the pulping step.

Based on the above, the present method is capable of reducing the direct CO₂ emission from the type of arrangement and method described herein. A major part (>50%) of the CO₂ in the off-gas from the calcination can be neutralized and recovered.

An additional advantage of the present invention is that the solids captured in the off-gas treatment step can be returned to the leaching step, which will provide a further route for reusing chemicals in a lithium recovery process.

The total amount of carbonate captured (typically as Na₂CO₃) in the off-gas treatment is sufficient to make up the total reagent demand of the pulping and leaching steps.

### BRIEF DESCRIPTION OF THE DRAWINGS

FIG. 1 is a diagram illustrating the units of the arrangement according to the invention.

FIG. 2 is a second embodiment illustrating the unites of arrangement.

FIG. 3 is a third embodiment illustrating the units of arrangement.

FIG. 4 is a fourth embodiment illustrating the units of the arrangement.

FIG. 5 is a fifth embodiment illustrating the units of the arrangement.

FIG. 6 is a sixth embodiment illustrating the units of the arrangement, wherein some of the optional details of the illustrated embodiments can be combined.

### EMBODIMENTS OF THE INVENTION

### Definitions

In the present context, the term “mineral” comprises materials obtained from the processing of metal-containing ores. The invention relates to particularly lithium-containing minerals, such as spodumene, petalite or lepidolite, or mixtures thereof.
The term “carbonate-containing solution” or “carbonate-containing liquid stream” is, in turn, intended to describe an aqueous solution used or formed in the various steps of the method that contains the carbonate species CO₃²⁻, HCO₃_{^{−}} and H₂CO₃, in various ratios compared to each other, depending on the pH of the solution.

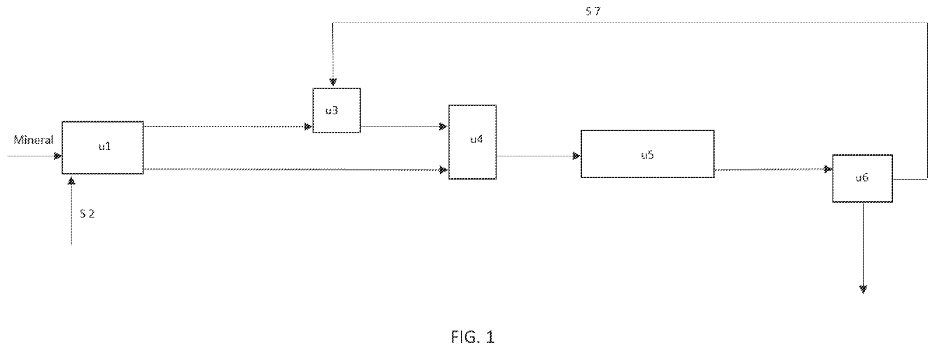

The present invention thus relates to an arrangement (see FIG. 1) for processing a lithium-containing mineral, including a heating unit u1, with a fuel inlet s2, for calcining the mineral into a calcined material containing lithium, further resulting in an off-gas, the arrangement further comprising
a pulping unit u4 connected to the heating unit u1, intended for forming an aqueous slurry from the calcined material,
a leaching unit u5 for reacting the calcined material with a leaching reagent, and
a solid-liquid separation unit u6 for separating lithium-containing solids from a solution containing leaching reagent, as well as
   an off-gas handling unit u3, connected to the heating unit u1, at least one section of the off-gas handling unit u3 being intended for washing the off-gas with a washing solution,
   whereby a recirculation line s7 connects the liquid side of the solid-liquid separation unit u6 to the off-gas handling unit u3.

Thus, the arrangement connects the slurry side of a lithium processing arrangement with the off-gas treatment using a recirculated liquid stream.

The heating unit u1 included in the arrangement of the invention is preferably a rotary kiln. Such a rotary kiln can be heated using a fuel, fed into the unit u1 through the fuel inlet s2, and burned therein, optionally combined with using one or more electrical heater(s). Thus, the heating unit u1 of the present invention typically comprises one or more heat sources, preferably including fuel-based heating, and optionally also an electrical heat source. The fuel-based heating is more advantageous due to the higher temperatures that can be achieved with the heating gas.

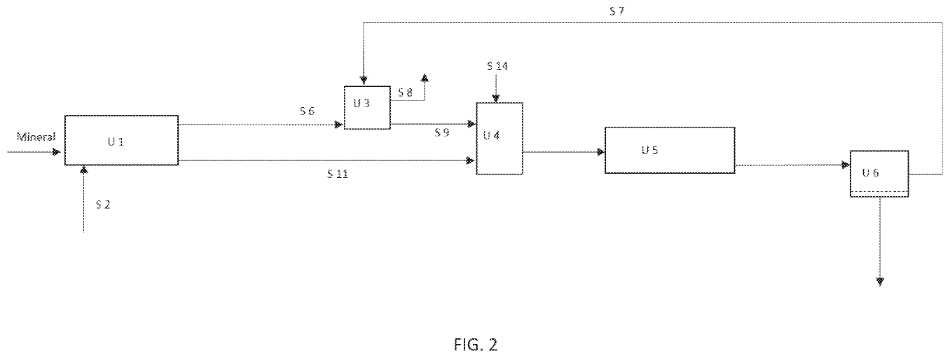

As shown in FIG. 2, to ensure that the leaching reagents can be added to the slurry to be leached already before the leaching takes place, the pulping unit u4 is typically equipped with an inlet s14 for an aqueous solution, said solution preferably containing the leaching reagent(s). The pulping unit also includes an inlet s11 for calcined material.

In an embodiment of the invention (see FIG. 2), the pulping unit u4 also includes an inlet s9 for a bleed solution circulated from the off-gas handling unit.

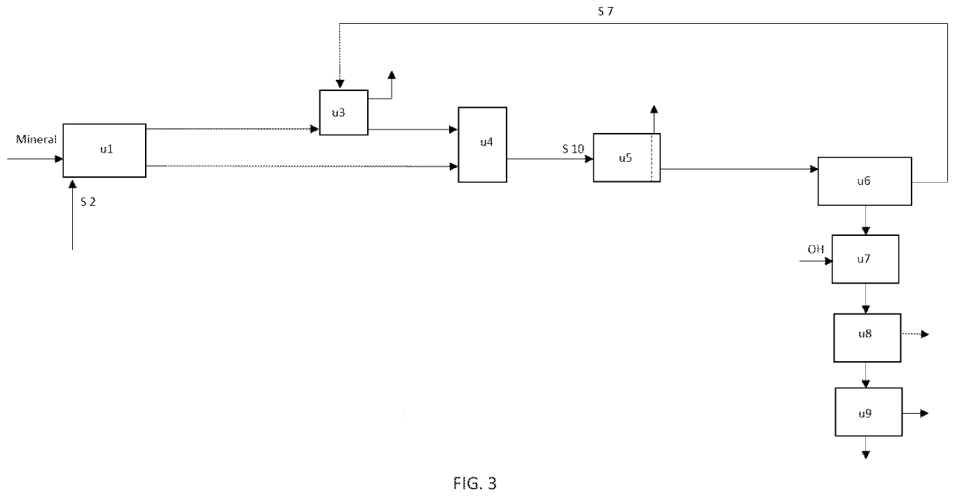

As indicated above, and in FIG. 1, a leaching unit u5 is positioned downstream from the pulping unit u4. Since the leaching unit u5 is required to withstand high pressures, it is typically in the form of an autoclave, and preferably includes a flash vessel, shown in FIG. 3 as a dashed line on the leaching unit u5. Thus, the leaching unit u5 is connected to the pulping unit u4 and as shown in FIG. 3, typically includes an inlet s10 for the aqueous slurry formed in the pulping unit u4.

The solid-liquid separation unit u6 can be connected to the leaching unit u5 via several alternatives.

According to one alternative, the solid-liquid separation unit u6 is directly connected to the leaching unit u5, the leaching unit u5, however, preferably including the flash vessel, as shown in FIG. 3.

In a preferred embodiment, as also shown in FIG. 3, the solids obtained from the solid-liquid separation unit u6 may be fed further to another leaching unit to be reacted further, e.g. to form lithium hydroxide from the carbonate formed in the first leaching unit u5. In such a hydroxide process, the solid-liquid separation unit u6 is preferably followed by a second leaching unit u7, equipped with a feed of hydroxide reagent, a second solid-liquid separation unit u8, optionally a purification unit and a lithium hydroxide crystallization unit u9. The solution from this hydroxide crystallization unit u9 can also be recirculated to one or more preceding units, with at least a fraction typically being recirculated to said second leaching unit u7. However, a further fraction can also be recirculated to either the pulping unit u4 or the first leaching unit u5.

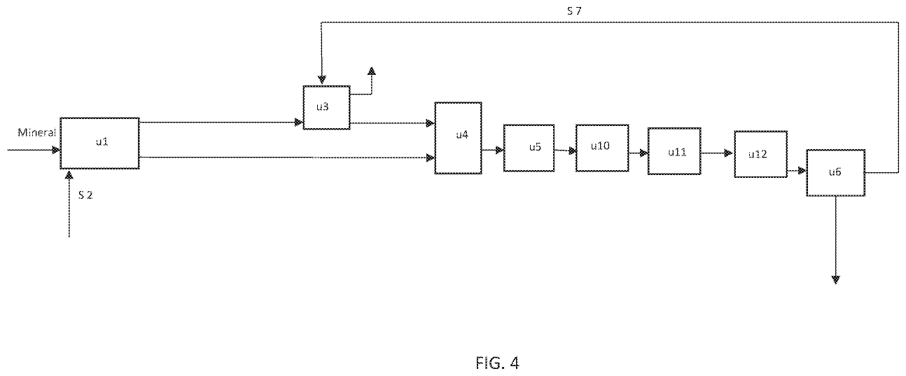

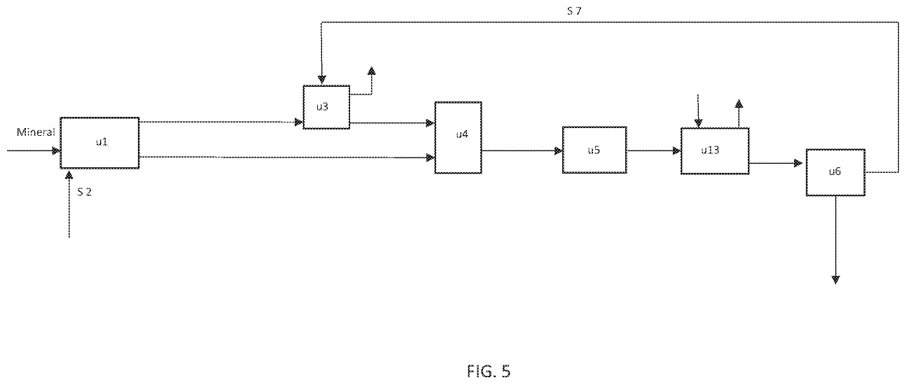

According to a second alternative, the solid-liquid separation unit u6 is connected to the leaching unit u5 via one or more intermediate units (see FIGS. 4 and 5).

Said intermediate units may include a carbonating unit u10 and a carbonate crystallization unit u12 (see FIG. 4), with a third solid-liquid separation unit u11 between them, whereby, instead of reacting the lithium carbonate into the hydroxide, as described above, the carbonate is carbonated in the carbonating unit u10 by using carbon dioxide (CO₂) to produce a solution containing lithium hydrogen carbonate, from which the lithium carbonate can then be crystallized in the carbonate crystallization unit u12. According to this option, the solid-liquid separation unit u6 is positioned downstream from the carbonate crystallization unit u12 to separate the formed carbonate crystals from the remaining solution. Said solution still contains the carbonates present in the leaching unit u5.

Said intermediate units may, optionally, include an atmospheric mixing reactor u13 (see FIG. 5) for dispersing air into the slurry obtained from the leaching unit u5, as well as for causing air-induced evaporation of a fraction of water from the slurry.

In this option, the flash vessel connected to the leaching unit u5 is required. The flash vessel is typically equipped with an outlet for off-gas, while the atmospheric mixing reactor u13 is equipped with an air inlet, an outlet for off-gas, as well as mixing gear in the form of a type of agitator, preferably in the form of an impeller. The flash vessel will cause a decrease in the pressure and temperature of the leached slurry, while the atmospheric mixing reactor u13 will disperse air into the leached slurry and cause air-induced evaporation of a fraction of the water of said slurry and simultaneous cooling thereof. The evaporation will also result in the formation of a fraction of off-gas containing moist air. Both the flash vessel and the atmospheric mixing reactor u13 will thus produce off-gases, which can be processed in separate off-gas handling units. Both the off-gas from the flash vessel and the off-gas from the atmospheric mixing reactor are preferably processed in off-gas handling systems being in the form of scrubbers, more preferably wet scrubbers, and most suitably venturi scrubbers. Each of these off-gas handling systems are typically equipped with water inlets, since a washing solution is needed also in these systems.

The advantages of said optional evaporation include that it will result in a smaller amount of liquid in the leached slurry, and consequently a smaller amount of slurry. As a result, the amount of air needed is smaller than in the commonly used cooling tower duty, whereby the amount of off-gas is smaller, not requiring such extensive devices and procedures for cleaning. Further, a more concentrated process stream will lead to a higher recovery of metals. The solid-liquid separation unit u6 can then either be positioned directly downstream from the atmospheric mixing reactor u13, to separate the lithium carbonate from the thus remaining concentrated solution, or the above described carbonating unit u10, third solid-liquid separation unit u11 and carbonate crystallization unit u12 can be positioned downstream from the atmospheric mixing reactor u13.

In an embodiment of the invention, the solid-liquid separation unit u6 is equipped with a washing section, as shown with a dashed line in FIG. 2, the washing section having a water inlet, and being equipped to wash the solids of the slurry, thus adding a washing solution to the solution already separated from the solids. This will provide higher yields of the desired fractions in the solution, and lower yields of impurities and by-products in the solids.

The separation unit u6, with its optional washing section, is preferably in the form of a filtration device.

The separation unit u6, or preferably its washing section, may also be connected to one or more off-gas handling units, e.g. unit u3, for reuse of at least a fraction of the water recovered from the off-gas handling system in said washing section.

The off-gas handling unit u3 of the invention typically includes an inlet s6 for off-gas and an outlet s8 for washed gas and evaporated water. These connections are also shown in FIG. 2.

Preferably, at least a section of the off-gas handling unit u3 is in the form of a wet gas scrubber, intended for washing the off-gas with a washing solution. This wet gas scrubber can be, for example, a venturi or packed bed scrubber.

Typically, not all of the off-gas and the washing solution turns into a gaseous fraction. Thus, as shown in FIG. 2, the off-gas handling unit typically also includes an outlet for a bleed solution, which preferably is returned to the pulping unit u4 via inlet s9, to be mixed with the carbonate-containing aqueous solution therein. Optionally, the bleed solution can be passed to the pulping unit u4 via a grinding unit.

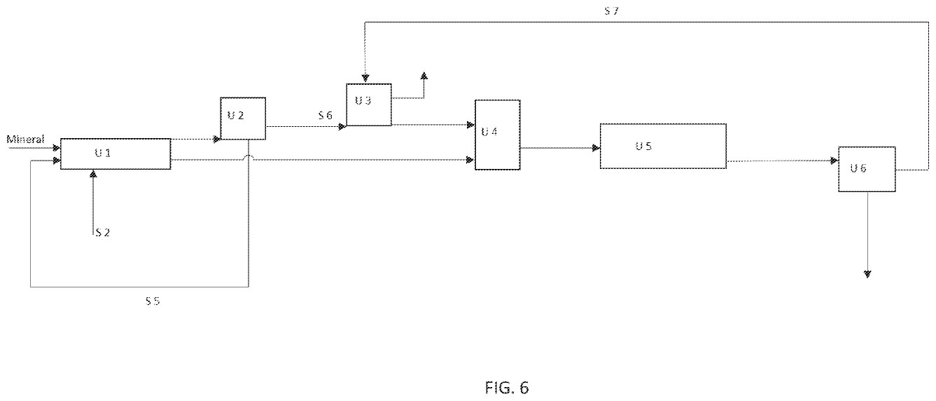

In an embodiment of the invention, shown in FIG. 6, a further section of the off-gas handling unit u3 is in the form of a solid-gas separator u2, which preferably is a cyclone separator. This optional solid-gas separator u2 is preferably positioned upstream from the washing section of the off-gas handling unit u3 that is intended for washing the off-gas with a washing solution. The optional solid-gas separator u2 typically includes an outlet s5 for an underflow, which preferably is connected by a circulation line to the heating unit u1.

The invention also relates to a method for processing a lithium-containing mineral, which method comprises calcining the mineral in one or more calcination steps at least one step utilizing the heat from a burning fuel, thus resulting in a calcined material containing lithium, as well as an off-gas, the method further comprising the steps of
pulping the calcined material into a slurry together with a leaching reagent in an aqueous solution,
leaching the formed slurry, and
separating lithium-containing solids in a solid-liquid separation step from a solution containing leaching reagent,
   as well as washing the off-gas obtained from the calcination step(s) with a washing solution, whereby at least a fraction of the liquid stream obtained in the solid-liquid separation step is recirculated to the off-gas washing step to be used as the washing solution.

The lithium-containing mineral is preferably selected from spodumene, petalite or lepidolite or mixtures thereof, more preferably being spodumene. When carrying out the calcination on the spodumene of the preferred option, it turns into the more soluble beta-spodumene (β-spodumene).

The calcination is typically carried out in one step, using one kiln. However, several heat sources may be used, one or more heat sources utilizing a fuel. A common type of fuel used in the calcination step is a carbon-containing fuel that forms an off-gas containing carbon dioxide (CO₂), e.g. natural gas or biogas.

In an embodiment of the invention, the calcination step also utilizes electrical heating.

The calcination step(s) is/are preferably carried out at a temperature of >800° C., more preferably about 1000-1150° C. This also results in an off-gas having an increased temperature when conducted from the calcination step to the off-gas washing step. Typically, the temperature of the off-gas is >100° C., when being fed to the washing step, more typically 200-400° C.

The pulping step is preferably carried out in the presence of an aqueous solution containing one or more alkali metal carbonates, more preferably a solution containing sodium carbonate. The pulping may be carried out in atmospheric conditions.

The leaching step, in turn, is preferably carried out at an increased temperature and increased pressure. A suitable temperature is within the range 100 to 250° C., preferably 150 to 230° C., and more preferably 200 to 220° C. A suitable pressure is between 2 and 60 bar, preferably 10 to 30 bar, and more preferably 15 to 25 bar.

The solid-liquid separation step mentioned above can be carried out either directly after the leaching step, or one or more intermediate steps can be carried out between the leaching step and the solid-liquid separation step.

In case the solid-liquid separation step is carried out directly after the leaching step, the separation is usually followed by the further steps required for preparing lithium hydroxide, such as a second leaching step in the presence of a hydroxide reagent, a second solid-liquid separation, an optional purification, and a lithium hydroxide crystallization. The solution from this crystallization can also be recirculated to one or more preceding steps, with at least a fraction typically being recirculated to the second leaching step. However, a further fraction can also be recirculated to either the pulping step or the first leaching step, described in further detail above.

When using said intermediate steps between the leaching step and the solid-liquid separation step described above, one alternative is to carry out intermediate steps including a carbonating step and a lithium recovery step. This route will result in the formation of a carbonate product, since the carbonating step, preferably carried out by adding carbon dioxide (CO₂), will result in the formation of lithium hydrogen carbonate, which in the recovery step, after a solid-liquid separation to remove solid mineral waste, typically is crystallized into the lithium carbonate. The solid-liquid separation step is then carried out to separate the formed carbonate crystals from the remaining solution. Said solution, however, still contains the carbonates from the leaching step. The crystallization also yields carbon dioxide, which can be recycled to upstream carbonation step.

When using said intermediate steps between the leaching step and the solid-liquid separation step described above, another alternative is to carry out intermediate steps including a flashing step and an atmospheric mixing step for dispersing air into the slurry obtained from the leaching step, as well as for causing air-induced evaporation of a fraction of water from the slurry.

Said flashing step will cause a decrease in the pressure and temperature of the leached slurry, while the atmospheric mixing reactor will disperse air into the leached slurry and cause air-induced evaporation of a fraction of the water of said slurry and simultaneous cooling thereof. The evaporation will also result in the formation of a fraction of off-gas containing moist air. Both the flash step and the atmospheric mixing step will thus produce off-gases, which can be processed in off-gas handling steps, e.g. by washing.

As stated above, the advantages of said optional evaporation include that it will result in a smaller amount of liquid in the leached slurry, and consequently a smaller amount of slurry, as well as a smaller amount of off-gas.

In this alternative, the solid-liquid separation step is then carried out to separate the lithium carbonate from the remaining concentrated solution, or the above described carbonating, separating and crystallization steps can also be carried out before said separation step.

The liquid stream obtained from the solid-liquid separation step is preferably an alkaline solution, more preferably a solution having a pH of 8-11.5. As stated above, this solution contains one or more carbonates, preferably one or more alkali metal carbonates, such as sodium carbonate (Na₂CO₃).

This liquid stream obtained from the above described solid-liquid separation step, or a fraction thereof, is recirculated to the off-gas washing step to be used as the washing solution, preferably as a dilute solution containing <5 w-% of carbonates.

In an embodiment of the invention, only a fraction of said liquid stream is recirculated to the off-gas washing step, while a further fraction is recirculated to either the pulping step or the leaching step, or a separate fraction to both.

The washing solution used in the off-gas washing step thus contains a fraction of the recirculated liquid stream obtained from the solid-liquid separation step. This liquid stream typically has a temperature of <100° C., whereby some of it will be efficiently evaporated when placed in contact with the off-gas having a temperature of >100° C.

The solution used to wash the off-gas may contain also added alkali metal hydroxide, preferably sodium hydroxide (NaOH), in order to cause further reaction of CO₂-containing off-gas to the corresponding alkali metal carbonate, preferably being sodium carbonate (Na₂CO₃).

In an embodiment of the present invention, a solid fraction is separated from the off-gas obtained from the calcination step in a solid-gas separation step before carrying the remaining off-gas to the off-gas washing step.

The obtained solid fraction is preferably recirculated to the calcination step in order to be processed further and carried to the calcined mineral material.

Typically, not all of the off-gas and the washing solution turns into a gaseous fraction. Instead, some solids tend to accumulate in the off-gas treatment. Further, a fraction of the circulated washing solution is preferably let out as a bleed. Thus, a bleed solution can be separated from the off-gas washing step. This bleed solution typically contains carbonate, which can be utilized in other steps. Preferably, this bleed solution is returned to the pulping step, to be mixed with the carbonate-containing aqueous solution therein. Optionally, the bleed solution can be passed via a grinding step.

In a particularly preferred embodiment of the invention, the above described method is carried out in the above described arrangement.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. In addition, various embodiments and examples of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In this description, numerous specific details are provided to provide a thorough understanding of embodiments of the invention. One skilled in the relevant art will recognize, however, that the invention can be practiced without one or more of the specific details.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The following non-limiting examples are intended merely to illustrate the advantages obtained with the embodiments of the present invention.

### EXAMPLES—RECIRCULATING A CARBONATE LIQUID STREAM AS PART OF A PROCESS FOR RECOVERING LITHIUM CARBONATE

### Example 1

An example case of the lithium carbonate process flowsheet was simulated with HSC-Sim simulation tool by Metso Outotec Oyj. The feed material to process was 10 tons per hour of dry, calcined spodumene concentrate with 6.0% Li₂O content.

The feed material stream to the pressure leaching step in an autoclave is prepared into a 25 wt-% aqueous slurry, including also the dissoluted reagent sodium carbonate. The lithium extraction results in a reaction according to the equation

2LiAlSi₂O₆+Na₂CO₃+2H₂O=2NaAlSi₂O₆*H₂O+Li₂CO₃

The reaction consumes approximately 2 t/h of reagent: sodium carbonate, assumed in calculation to take place at 200° C. Solid intermediate lithium carbonate is formed in reaction as well as analcime mineral residue. The direct steam feed requirement to the pressure leaching step is approx. 4 t/h to reach the desired temperature for the reaction slurry. The process slurry is taken out to atmospheric conditions via a flashing step, which evaporates simultaneously totally 6 t/h of water vapour. The slurry is fed downstream to atmospheric carbonation step, which is assumed to be done, cooled down at 35° C. with an external heat exchanger. The carbonation takes place according to reaction:

Li₂CO₃+CO₂(g)+H₂O=2LiHCO₃

After the carbonation the lithium hydrogen carbonate solution is separated in a filter and 16 t/h of moist (icl. 20% moisture) mineral residue cake is taken as a solid output stream. The cake is washed with water: 1.5 m³ water per ton of dry solids=17 m³/h. Wash filtrate is recycled back to carbonation step and filtrate is taken to lithium carbonate recovery step.

Lithium carbonate is spontaneously crystallized via heating the solution to 90° C. and simultaneously, carbon dioxide is released, according to following reaction:

2LiHCO₃(aq)=Li₂CO₃(s)+CO₂(g)+H₂O

Carbon dioxide is typically recycled to upstream carbonation step in a continuous process. 1.3 tons per hour of product lithium carbonate solid is produced with 80% recovery yield. Total 1.5 t/h solid cake is separated on a filter, including 15% moisture content.

The crystallization yield of lithium carbonate is not 100% complete, but typically closer to 70-80% since there will remain residual lithium in solution due to slight solubility of lithium carbonate and lithium hydrogen carbonate in water even at this high temperature. The lithium carbonate recovery is further enhanced by bringing the solution pH up to >11, where carbonate is the dominant species in solution. pH adjustment is done with NaOH solution:

OH⁻+HCO₃⁻=CO₃²⁻+H₂O

Thus, the filtrate stream is a dilute solution, containing both lithium and sodium carbonate. This solution is fed as a make-up water to calciner wet gas scrubber, where the hot exhaust gas from kiln is washed off the solid particles (=0.2 t/h). The kiln off-gas is assumed to comprise: 7 t/h nitrogen and residual 0.2 t/h oxygen from air fed to the burner and 1.5 t/h carbon dioxide as result from fuel burning. Additionally, the gas contains some water (1 t/h), because the feed material (spodumene concentrate has been assumed to be fed to calcining kiln containing some 10% moisture). Concentrated NaOH solution is fed to the scrubber circuit to neutralize and recover major part (>50%) of the carbon dioxide in off-gas to result sodium carbonate in solution. The scrubber solution is taken out at 90° C., and will be recycled to slurry preparation. The sodium carbonate captured in wet scrubber is sufficient to make up the total reagent demand of the process (=2 t/h). The amount of evaporated water in scrubber circuit is 1 t/h.

### Example 2

Another example for the same case of 10 t/h spodumene feed with 6% Li₂O content but with Lithium hydroxide as a product was simulated similarly. The feed material to process was 10 tons per hour of dry, calcined spodumene concentrate with 6.0% Li₂O content. The feed material stream to the pressure leaching step in an autoclave is prepared into a 25 wt-% aqueous slurry, including also the dissolved reagent, sodium carbonate. The lithium extraction, according to the equation

2LiAlSi₂O₆+Na₂CO₃+2H₂O=2NaAlSi₂O₆*H₂O+Li₂CO₃

The reaction consumes approximately 2 t/h of reagent: sodium carbonate, assumed in calculation to take place at 220° C. Solid intermediate lithium carbonate is formed in reaction along with the analcime mineral residue. The direct steam feed requirement to the pressure leaching step is approximately 7 t/h to reach the desired temperature for the reaction slurry. The process slurry is taken out to atmospheric conditions via a flashing step, which evaporates approximately 6 t/h of water vapour. The slurry is then fed to the filtration where solids are dewatered and transferred to the next process stage to convert Li₂CO₃ to LiOH. The total filtrate amount is ˜35 t/h and spent wash filtrate 9 t/h. Most of the filtrate and wash filtrate are recirculated back to the start of the slurry preparation step, but part of the solutions have to be bled out of the circulation to the effluent treatment due to the water balance and impurity buildup.

The filtrate streams are dilute solutions, containing both lithium and sodium carbonate. A part of these solutions, 5.1 t/h, is fed as a make-up water to calciner wet gas scrubber, where the hot exhaust gas from kiln is washed off the residual solid particles (=0.2 t/h). The kiln off-gas is assumed to comprise: 7 t/h nitrogen and residual 0.2 t/h oxygen from air fed to the burner and 1.5 t/h carbon dioxide as result from fuel burning. Additionally, the gas contains some water (1 t/h), because the feed material (spodumene concentrate has been assumed to be fed to calcining kiln containing some 10% moisture). The contact to the hot gas evaporates part of the scrubber water and thus removes this part from the circulation, minimizing the need for bleed and effluent treatment. The scrubber solution is taken out at 90 C and will be recycled to slurry preparation. The water evaporation amount is roughly 1 t/h in the scrubber.

### REFERENCE SIGNS LIST

As shown in the FIGS. 1-6, the following units can be included in the arrangement of the present invention, according to one or more embodiments of the invention:
u1 heating unit
u2 optional solid-gas separator
u3 off-gas handling unit
u4 pulping unit
u5 leaching unit
u6 solid-liquid separation unit
u7 optional second leaching unit
u8 optional second solid-liquid separation unit
u9 optional hydroxide crystallization unit
u10 optional carbonating unit
u11 optional third solid-liquid separation unit
u12 optional carbonate crystallization unit
u13 optional atmospheric mixing reactor

Likewise, the following lines, inlets and outlets can be included in the arrangement according one or more embodiments:
s2 fuel inlet on heating unit u1
s5 optional outlet on solid-gas separator u2, for underflow
s6 inlet on off-gas handling unit u3 for off-gas
s7 recirculation line between solid-liquid separation unit u6 and off-gas handling unit u3
s8 outlet on off-gas handling unit u3 for washed off-gas and evaporated water
s9 optional inlet on pulping unit u4 for bleed solution
s10 inlet on leaching unit u5 for aqueous slurry
s11 inlet on pulping unit u4 for calcined material
s14 optional separate inlet on pulping unit u4 for aqueous solution

### INDUSTRIAL APPLICABILITY

The present arrangement can be used to provide a novel route for the recirculation of the carbonate-containing liquid stream that is formed in the leaching of lithium-containing slurries as part of the hydrometallurgical processes for recovering lithium from minerals.

1. An arrangement for processing a lithium-containing mineral, including a heating unit with a fuel inlet for calcining the mineral into a calcined material containing lithium, further resulting in an off-gas, the arrangement further comprising:
a pulping unit connected to the heating unit, intended for forming an aqueous slurry from the calcined material,
a leaching unit for reacting the calcined material with a leaching reagent, and
a solid-liquid separation unit for separating lithium-containing solids from a solution containing leaching reagent,
an off-gas handling unit, connected to the heating unit, at least one section of the off-gas handling unit being intended for washing the off-gas with a washing solution,
whereby a recirculation line connects the liquid side of the solid-liquid separation unit to the off-gas handling unit.

2. The arrangement according to claim 1, wherein the heating unit is a rotary kiln.

3. The arrangement according to claim 1, wherein the heating unit includes one or more heat sources, including fuel-based heating.

4. The arrangement according to claim 1, wherein the heating unit includes an electrical heat source.

5. The arrangement according to claim 1, wherein the pulping unit includes an inlet for an aqueous solution, said solution preferably containing the leaching reagent(s), and an inlet for calcined material.

6. The arrangement according to claim 1, wherein the pulping unit includes an inlet for a bleed solution circulated from the off-gas handling unit.

7. The arrangement according to claim 1, wherein the leaching unit is an autoclave.

8. The arrangement according to claim 1, wherein the leaching unit is connected to the pulping unit and includes an inlet for the aqueous slurry formed in the pulping unit.

9. The arrangement according to claim 1, wherein the leaching unit includes, or is connected to, one or more flash vessels.

10. The arrangement according to claim 1, wherein the leaching unit is connected to the solid-liquid separation unit, on which the solid side is connected to a second leaching unit, equipped with a feed of hydroxide reagent, a second solid-liquid separation unit, optionally a purification unit, and a lithium hydroxide crystallization unit.

11. The arrangement according to claim 1, wherein the solid-liquid separation unit is connected to the leaching unit via one or more intermediate units.

12. The arrangement according to claim 11, wherein the intermediate units include a carbonating unit, third solid-liquid separation unit and a carbonate crystallization unit.

13. The arrangement according to claim 11, wherein the intermediate units include an atmospheric mixing reactor for dispersing air into the slurry obtained from the leaching unit, as well as for causing air-induced evaporation of a fraction of water from the slurry, the leaching unit thus including, or being connected to, one or more flash vessels.

14. The arrangement according to claim 1, wherein at least a section of the off-gas handling unit is in the form of a wet gas scrubber, intended for washing the off-gas with a washing solution.

15. The arrangement according to claim 1, wherein the off-gas handling unit includes an inlet for off-gas and an outlet for washed gas and evaporated water.

16. The arrangement according to claim 1, wherein at least a section of the off-gas handling unit is in the form of a solid-gas separator, which preferably is in the form of a cyclone separator.

17. The arrangement according to claim 1, wherein at least a section of the off-gas handling unit is in the form of a solid-gas separator, which preferably is positioned upstream from a washing section of the off-gas handling unit.

18. The arrangement according to claim 16, wherein the solid-gas separator includes an outlet for an underflow, which preferably is connected by a circulation line to the heating unit.

19. A method for processing a lithium-containing mineral, which method comprises calcining the mineral in one or more calcination steps, at least one step utilizing the heat from a burning fuel, thus resulting in a calcined material containing lithium, as well as an off-gas, the method further comprising the steps of:
pulping the calcined material into a slurry together with a leaching reagent in an aqueous solution,
leaching the formed slurry, and
separating lithium-containing solids in a solid-liquid separation step from a solution containing leaching reagent,
washing the off-gas obtained from the calcination step(s) with a washing solution,
whereby at least a fraction of the liquid stream obtained in the solid-liquid separation step is recirculated to the off-gas washing step to be used as the washing solution.

20. The method according to claim 19, wherein the mineral is selected from spodumene, petalite or lepidolite or mixtures thereof, preferably being spodumene.

21. The method according to claim 19, wherein the fuel used in the calcination step is a carbon-containing fuel, preferably containing or consisting of natural gas or biogas.

22. The method according to claim 19, wherein the calcination step utilizes electrical heating.

23. The method according to claim 19, wherein the calcination step(s) is/are carried out at a temperature of >800° C., preferably about 1000-1150° C.

24. The method according to claim 19, wherein the pulping step is carried out in the presence of an aqueous solution, preferably containing one or more alkali metal carbonates, more preferably containing sodium carbonate, and most suitably carried out in atmospheric conditions.

25. The method according to claim 19, wherein the leaching step is carried out at a temperature of 100 to 250° C., preferably at a temperature of 150 to 230° C., and more preferably at a temperature of 200 to 220° C.

26. The method according to claim 19, wherein the leaching step is carried out at a pressure of 2 to 60 bar, preferably 10 to 30 bar, and more preferably 15 to 25 bar.

27. The method according to claim 19, wherein one or more intermediate steps are carried out between the leaching step and the solid-liquid separation step.

28. The method according to claim 27, wherein the intermediate steps include a carbonating step and a lithium recovery step, the latter carried out on the carbonated solution.

29. The method according to claim 27, wherein the intermediate steps include a flashing step and an atmospheric mixing step for dispersing air into the slurry obtained from the leaching step, as well as for causing air-induced evaporation of a fraction of water from the slurry.

30. The method according to claim 19, wherein the liquid stream obtained from the solid-liquid separation step is an alkaline solution, preferably having a pH of 8-11.5.

31. The method according to claim 19, wherein the liquid stream obtained from the solid-liquid separation step is an alkaline solution containing one or more carbonates, preferably one or more alkali metal carbonates, such as sodium carbonate (Na₂CO₃).

32. The method according to claim 19, wherein the washing solution used in the off-gas washing step contains the recirculated liquid stream obtained from the solid-liquid separation step, preferably having a temperature of <100° C.

33. The method according to claim 19, wherein the step of washing the off-gas includes adding an alkali metal hydroxide, preferably being sodium hydroxide (NaOH), to the washing solution.

34. The method according to claim 19, wherein a solid fraction is separated from the off-gas obtained from the calcination step in a solid-gas separation step before carrying the remaining off-gas to the off-gas washing step.

35. The method according to claim 34, wherein the solid fraction is recirculated to the calcination step.

36. The method according to claim 19, wherein a carbonate-containing bleed solution is separated from the off-gas washing step, and is returned to the pulping step, to be mixed with the aqueous solution therein.

37. The method according to claim 19, wherein the solid-liquid separation step is followed by a second leaching step, carried out on the solids using a hydroxide reagent, a second solid-liquid separation step, and a step of crystallizing the obtained lithium hydroxide.

38. The method according to claim 19, which is carried out in the arrangement of claim 1.
